(19) United States
(12) Patent Application Publication
(10) Pub. No.: US 2026/0229818 A1
(43) Pub. Date: Aug. 6, 2026

(54) Pressing Device and Electrical Connection

(71) Applicant: Tyco Electronics (Shanghai) Co., Ltd., Shanghai (CN)

(72) Inventors: Guibin (Gabby) Lin, Foshan (CN); Jiefeng (Lear) Zhang, Shanghai (CN); Zhiqiang (Simon) Li, Shanghai (CN); Jinqiang (Jeff) Wang, Qingdao (CN); Tingting Zhang, Shanghai (CN); Guoxiao (Neo) Shen, Shanghai (CN)

(73) Assignee: Tyco Electronics (Shanghai) Co., Ltd., Shanghai (CN)

(21) Appl. No.: 19/530,460

(22) Filed: Feb. 5, 2026

(30) Foreign Application Priority Data
Feb. 5, 2025 (CN) 202510129791.6

(51) Int. Cl. H01R 13/627; H01R 12/70; H01R 13/645; H01R 43/26

(52) U.S. Cl. CPC H01R 13/6275; H01R 12/7029; H01R 12/7052; H01R 12/7058; H01R 13/645; H01R 43/26

(57) ABSTRACT

A pressing device includes a bottom plate and a pressing rod member. The bottom plate is fixed to the circuit board. An elastic buckle is formed on the bottom plate. The pressing rod member is rotatably connected to the bottom plate and rotatable between a closed position of pressing a connector onto the circuit board and an open position of releasing the connector. The elastic buckle engages with the pressing rod member when the pressing rod member is rotated to the closed position. The elastic buckle engaged with the pressing rod member locks the pressing rod member in the closed position.

### CROSS-REFERENCE TO RELATED APPLICATION

This application claims the benefit of the filing date under 35 U.S.C. § 119(a)-(d) of Chinese Patent Application No. CN202510129791.6 filed on Feb. 5, 2025, the whole disclosure of which is incorporated herein by reference.

### FIELD OF THE INVENTION

The present invention relates to a pressing device and, more particularly, to a pressing device and an electrical connection assembly comprising the pressing device.

### BACKGROUND OF THE INVENTION

In order to press and fix a connector to a circuit board, it is usually necessary to provide a bottom plate and a top cover. The bottom plate is fixed to the circuit board, and the top cover is pressed onto a top of the connector. A nut is fixed on the bottom plate, and a bolt passes through the top cover and is threaded with the nut on the bottom plate to press and fix the connector on the circuit board. The top cover is usually a machined part with high cost, and the size of the top cover in the height direction is relatively large, requiring a predetermined height to protrude from the top of the connector, which is not conducive to the miniaturization of electrical connection products.

### SUMMARY OF THE INVENTION

A pressing device includes a bottom plate and a pressing rod member. The bottom plate is fixed to the circuit board. An elastic buckle is formed on the bottom plate. The pressing rod member is rotatably connected to the bottom plate and rotatable between a closed position of pressing a connector onto the circuit board and an open position of releasing the connector. The elastic buckle engages with the pressing rod member when the pressing rod member is rotated to the closed position. The elastic buckle engaged with the pressing rod member locks the pressing rod member in the closed position.

### BRIEF DESCRIPTION OF DRAWINGS

The invention will now be described by way of example with reference to the accompanying figures, of which:

FIG. 1 is a perspective view of an electrical connection assembly according to an exemplary embodiment;

FIG. 2 is an exploded view of the electrical connection assembly of FIG. 1;

FIG. 3 is an exploded view of a bottom plate, a circuit board, and a back plate of the electrical connection assembly of FIG. 1;

FIG. 4 is a perspective view of a pressing device of the electrical connection assembly of FIG. 1;

FIG. 5 is a side view of the electrical connection assembly of FIG. 1, with a pressing rod member in a closed position;

FIG. 6 is a side view of the electrical connection assembly of FIG. 1, with the pressing rod member of FIG. 5 in an open position;

FIG. 7 is a perspective view of an electrical connection assembly according to another exemplary embodiment; and

FIG. 8 is a partial exploded view of the electrical connection assembly of FIG. 7.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

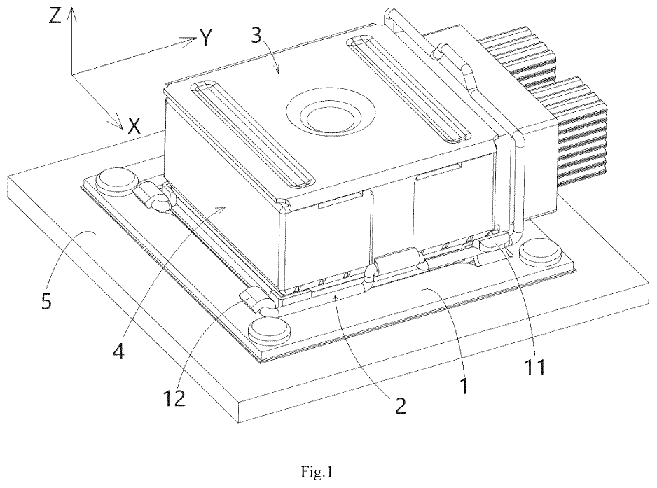

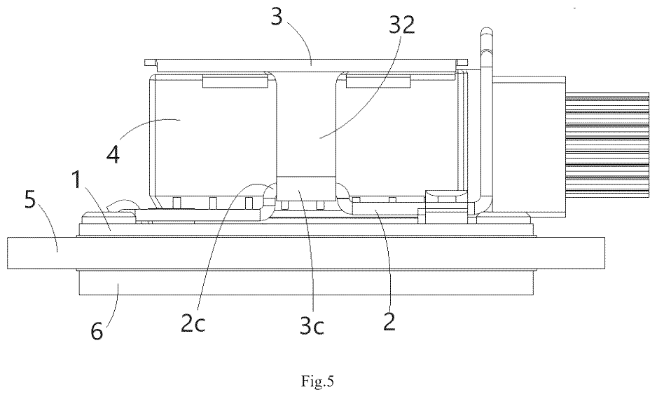

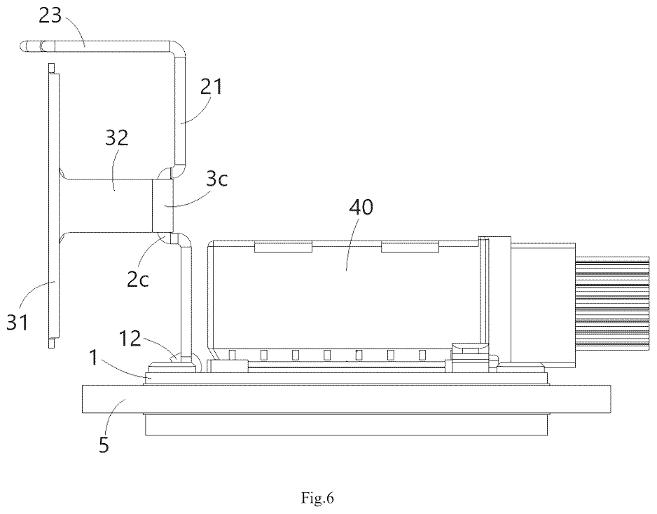

An exemplary embodiment of a pressing device will now be described with reference to FIGS. 1-6. As shown in FIG. 1, the pressing device includes: a bottom plate 1 and a pressing rod member 2. The bottom plate 1 is suitable for being fixed to a circuit board 5, as shown in FIGS. 1 and 5-6. The pressing rod member 2 is rotatably connected to the bottom plate 1, and can be rotated between a closed position, as shown in FIG. 5, of pressing a connector 4 onto the circuit board 5 and an open position, as shown in FIG. 6, of releasing the connector 4. An elastic buckle 11, as shown in FIGS. 1-4, is formed on the bottom plate 1, which engages with the pressing rod member 2 when it is rotated to the closed position to lock the pressing rod member 2 in the closed position. The pressing rod member 2 can be an integral piece formed by bending a rod material.

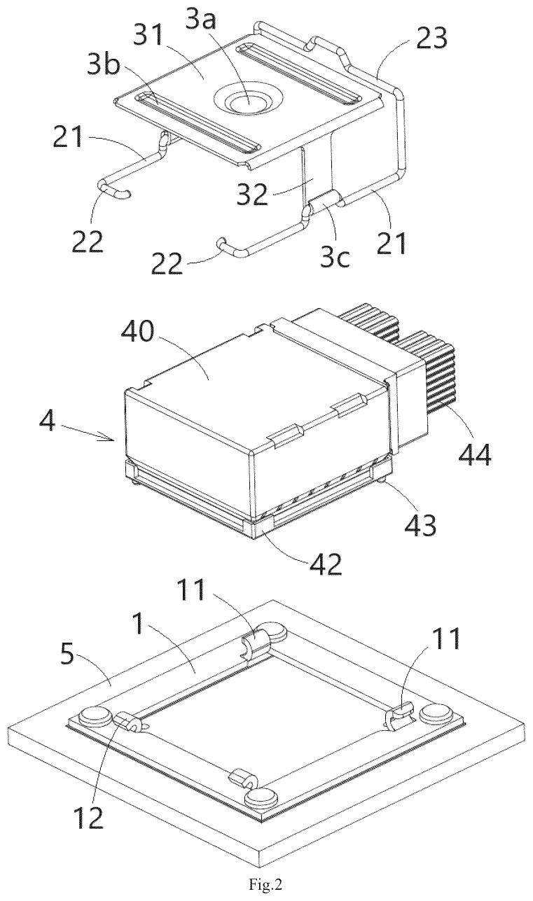

As shown in FIG. 2, the pressing rod member 2 includes a pair of pressing rods 21, a pair of front end rods 22, and a U-shaped rod 23. The pair of pressing rods 21 are spaced apart in a transverse direction X and have front and rear ends that are opposite in a longitudinal direction Y. The pair of front end rods 22 are respectively connected to the front ends of the pair of pressing rods 21. The two ends of U-shaped rod 23 are respectively connected to the rear ends of the pair of pressing rods 21. The pair of front end rods 22 are rotatably connected to the bottom plate 1, allowing the pressing rod member 2 to rotate between the open position and the closed position. The pair of pressing rods 21 are used to apply a predetermined pressing force on the connector 4, and the U-shaped rod 23 is used as a handle for rotating the pressing rod member 2.

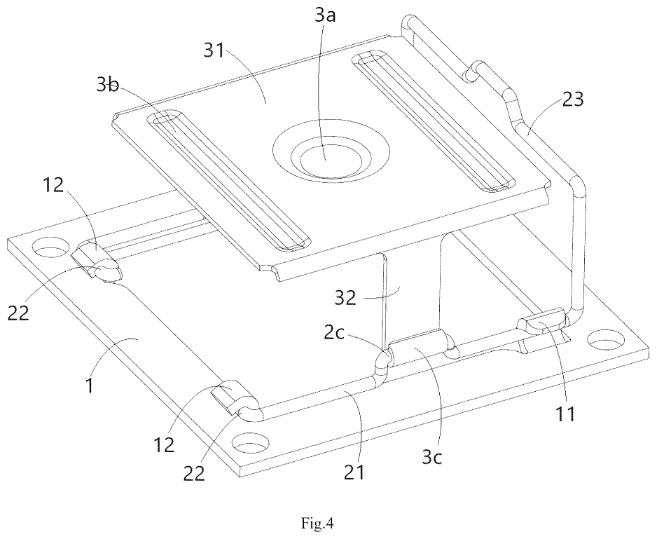

As shown in FIG. 4, a pair of elastic buckles 11 are formed on the bottom plate 1. When the pressing rod member 2 is rotated to the closed position, the pair of elastic buckles 11 respectively engage with the rear ends of the pair of pressing rods 21 of the pressing rod member 2 to lock the pressing rod member 2 in the closed position. Each elastic buckle 11 is rolled into a curved hook shape. The rear end of the pressing rod 21 is adapted to be joined to the curved hook shaped elastic buckle 11.

As shown in FIGS. 2-4 and 6, a pair of connecting parts 12 that are rolled into a C shape are formed on the bottom plate 1. As shown FIG. 4, the pair of front end rods 22 of the pressing rod member 2 are respectively rotatably joined to the pair of connecting parts 12, so that the pressing rod member 2 can be rotated around an axis extending along the transverse direction X.

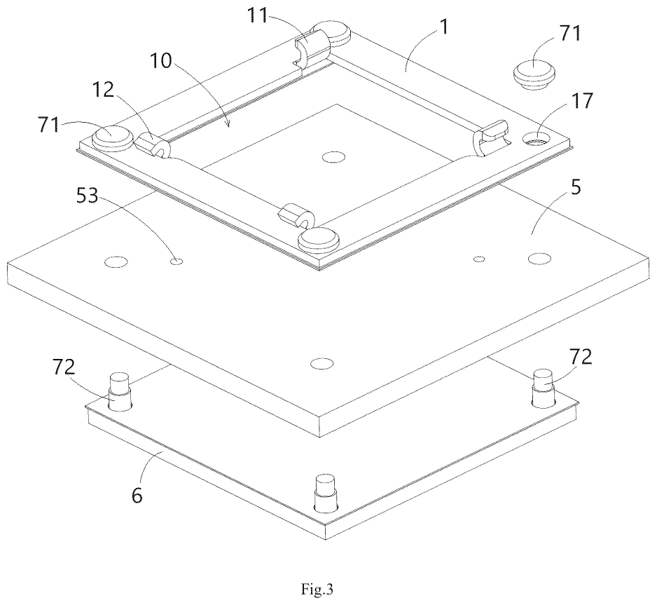

The bottom plate 1 can be an integral stamped part. As shown in FIG. 3, a positioning window 10 is formed on the bottom plate 1. The positioning window 10 is suitable for mating with a base 42 of the connector 4 to position the connector 4 in the positioning window 10 of the bottom plate 1.

As shown in FIG. 3, the connecting part 12 is a tongue connected to the side edge of the positioning window 10 and rolled into a C-shaped shape, and the elastic buckle 11 is a tongue connected to the side edge of the positioning window 10 and rolled into a curved hook shape.

As shown in FIG. 3, riveting holes 17 are formed in the bottom plate 1, and the pressing device further includes nuts 71 riveted into the riveting holes 17 of the bottom plate 1. The nuts 71 are used to connect with bolts 72 passing through the circuit board 5 to fix the bottom plate 1 to the circuit board 5.

As shown in FIGS. 1 and 5, the pressing device further comprises a pressing cover 3. The lateral sides of the pressing cover 3 are respectively connected to the pair of pressing rods 21 of the pressing rod member 2. When the pressing rod member 2 is rotated to the closed position, the pressing cover 3 is adapted to press on the top of the housing 40 of the connector 4 to press the connector 4 onto the circuit board 5. As shown in FIG. 6, the pressing cover 3 includes a top plate 31 and a pair of connecting plates 32 connected to the lateral sides of the top plate 31. The pair of pressing rods 21 of the pressing rod member 2 are connected to the pair of connecting plates 32 of the pressing cover 3, and the top plate 31 of the pressing cover 3 is used to press on the top of the housing 40 of the connector 4.

As shown in FIGS. 4-6, an upward protruding U-shaped buckle 2c is formed on the pressing rod 21 of the pressing rod member 2, and a hook shaped part 3c is formed at the lower end of the connecting plate 32 of the pressing cover 3. The hook shaped part 3c of the connecting plate 32 is engaged with the U-shaped buckle 2c of the pressing rod 21.

As shown in FIG. 4, a pressing protrusion 3a and/or a pressing rib 3b are formed on the top plate 31 of the pressing cover 3, which are used to press against the top of the housing 40 of the connector 4. As shown in FIG. 1, the pressing cover 3 is a one-piece stamped part.

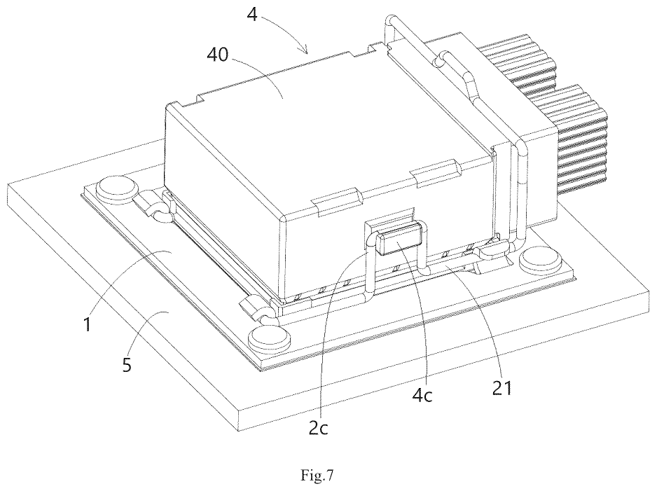

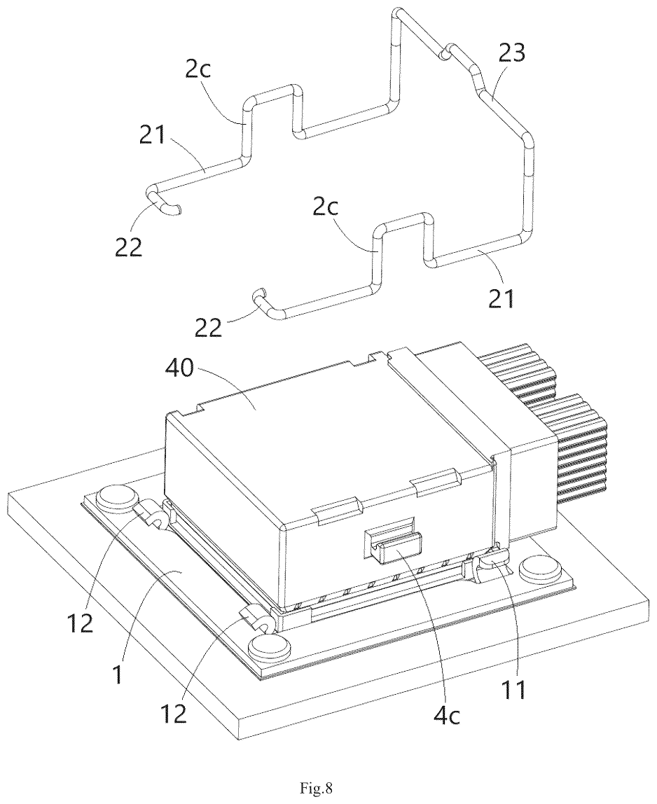

Exemplary embodiments of an electrical connection assembly according to FIGS. 1-6 and an electrical connection assembly according to FIGS. 7-8 will now be described. The main difference between the electrical connection assembly shown in FIGS. 7-8 and the electrical connection assembly shown in FIGS. 1-6, is that the pressing cover 3 is removed, and the pressing rod member 2 is directly engaged with the housing 40 of the connector 4. In addition, other technical features of the electrical connection assembly shown in FIGS. 7-8 are basically the same as those of the electrical connection assembly shown in FIGS. 1-6, which can be referred to as the electrical connection assembly shown in FIGS. 1-6.

As shown in FIGS. 7-8, an upward protruding U-shaped buckle 2c is formed on the pressing rod 21 of the pressing rod member 2. As shown in FIG. 7, the U-shaped buckle 2c of the pressing rod 21 is adapted to engage with the hook part 4c on the housing 40 of the connector 4, so that the connector 4 can be pressed onto the circuit board 5 by pressing the hook part 4c.

Each electrical connection assembly includes: a circuit board 5, a connector 4, and the aforementioned pressing device. The connector 4 is installed on the front surface of the circuit board 5. The bottom plate 1 of the pressing device is fixed to the front surface of the circuit board 5. The pressing device applies a predetermined pressing force on the connector 4, causing the connector 4 to be pressed onto the front surface of the circuit board 5.

As shown in FIGS. 2 and 6, the connector 4 includes a housing 40 and a terminal. The terminal is set in the housing 40. The pressing device includes a pressing cover 3 connected to the pressing rod member 2, and applies a predetermined downward pressing force on the top of the housing 40 of the connector 4 through the pressing cover 3.

As shown in FIGS. 7-8, the connector 4 includes a housing 40 and a terminal. Hook parts 4c are respectively formed on the outer sides of the two side walls of the housing 40. The terminal is set in the housing 40. The pair of pressing rods 21 of the pressing device have U-shaped buckles 2c, and the U-shaped buckles 2c of the pair of pressing rods 21 are respectively engaged with the hook parts 4c on the two side walls of the housing 40. The pressing device applies a predetermined downward pressing force on the housing 40 by pressing the hook parts 4c of the housing 40.

As shown in FIG. 2, the connector 4 further comprises a base 42, which is mounted to the bottom of the housing 40, and a cable 44. The cable 44 is electrically connected to the terminal and extends from the housing 40. Multiple positioning pins 43 are formed on the bottom surface of the base 42, and multiple positioning holes 53, as shown in FIG. 3, are formed in the circuit board 5. The positioning pins 43 are respectively mated with the multiple positioning holes 53 to position the connector 4 on the circuit board 5. The connector 4 shown in FIGS. 7-8 also has the base 42, the cable 44, and the multiple positioning pins 43, and the circuit board 5 of FIGS. 7-8 has the multiple positioning holes 53.

As shown in FIG. 5, the electrical connection assembly further includes a back plate 6 and a fastening assembly. The back plate 6 is located on the back surface of the circuit board 5. The fastening assembly is used to secure the back plate 6 and bottom plate 1 to the circuit board 5. The electrical connection assembly according to FIGS. 7-8 also further includes the back plate 6 and the fastening assembly. As shown in FIG. 3, the fastening assembly includes a nut 71 and a bolt 72. The nut 71 is riveted to the bottom plate 1. The bolt 72 passes through the back plate 6, the circuit board 5, and the bottom plate 1 and is threaded with the nut 71.

In the aforementioned exemplary embodiments according to the present invention, the pressing rod member 2 has a small volume and low cost, which not only enables miniaturization of the electrical connection product, but also reliably presses the connector 4 onto the circuit board 5.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A pressing device, comprising:
a bottom plate fixed to a circuit board, an elastic buckle is formed on the bottom plate; and
a pressing rod member rotatably connected to the bottom plate and rotatable between a closed position of pressing a connector onto the circuit board and an open position of releasing the connector, the elastic buckle engages with the pressing rod member when the pressing rod member is rotated to the closed position, the elastic buckle engaged with the pressing rod member locks the pressing rod member in the closed position.

2. The pressing device of claim 1, wherein the pressing rod member is an integral piece formed by bending a rod material.

3. The pressing device of claim 1, wherein the pressing rod member includes a pair of pressing rods, a pair of front end rods, and a U-shaped rod, the pair of pressing rods are spaced apart in a transverse direction and each have a front end and a rear end opposite in a longitudinal direction, the pair of front end rods are each respectively connected to the front ends of the pair of pressing rods, the U-shaped rod has two ends respectively connected to the rear ends of the pair of pressing rods, the pair of front end rods are rotatably connected to the bottom plate allowing the pressing rod member to rotate between the open position and the closed position, the pair of pressing rods apply a predetermined pressing force on the connector, and the U-shaped rod is usable as a handle to rotate the pressing rod member.

4. The pressing device of claim 3, wherein a pair of elastic buckles are formed on the bottom plate, when the pressing rod member is rotated to the closed position, the pair of elastic buckles are respectively engaged with the rear ends of the pair of pressing rods to lock the pressing rod member in the closed position.

5. The pressing device of claim 4, wherein each elastic buckle is rolled into a curved hook shape, the rear end of each pressing rod engages into one curved hook shaped elastic buckle.

6. The pressing device of claim 3, wherein a pair of connecting parts that are rolled into a C shape are formed on the bottom plate, the pair of front end rods are respectively rotatably engaged in the pair of connecting parts such that the pressing rod member is rotatable around an axis extending along the transverse direction.

7. The pressing device of claim 6, wherein the bottom plate is an integral stamped part.

8. The pressing device of claim 6, wherein a positioning window is formed on the bottom plate, the positioning window mates with a base of the connector to position the connector in the positioning window.

9. The pressing device of claim 8, wherein each connecting part is a tongue connected to a side edge of the positioning window and rolled into a C-shaped shape, and each elastic buckle is a tongue connected to one side edge of the positioning window and rolled into a curved hook shape.

10. The pressing device of claim 1, wherein a rivet hole is formed in the bottom plate, and the pressing device further comprises a nut riveted into the rivet hole of the bottom plate, the nut connects with a bolt passing through the circuit board to fix the bottom plate to the circuit board.

11. The pressing device of claim 3, further comprising a pressing cover having two opposite lateral sides in a transverse direction of the pressing cover, each lateral side of the pressing cover is respectively connected to the pair of pressing rods, when the pressing rod member is rotated to the closed position, the pressing cover presses on a top of a housing of the connector to press the connector onto the circuit board.

12. The pressing device of claim 11, wherein the pressing cover has a top plate and a pair of connecting plates respectively connected to the lateral sides of the top plate, the pair of pressing rods are respectively connected to the pair of connecting plates, the top plate presses on the top of the housing of the connector.

13. The pressing device of claim 12, wherein a U-shaped buckle protruding upwards is formed on each pressing rod, and a hook shaped part is formed at a lower end of each connecting plate, each hook shaped part is engaged with one U-shaped buckle.

14. The pressing device of claim 12, wherein a pressing protrusion and/or a pressing rib are formed on the top plate of the pressing cover, the pressing protrusion and/or the pressing rib press on the top of the housing of the connector.

15. The pressing device of claim 12, wherein the pressing cover is an integral stamped part.

16. The pressing device of claim 3, wherein a U-shaped buckle protruding upwards is formed on each pressing rod, each U-shaped buckle engages with a hook part on a housing of the connector, when the hook part is pressed the connector is pressed onto the circuit board.

17. An electrical connection assembly, comprising:
a circuit board having a front surface and a back surface opposite in a thickness direction of the circuit board;
a connector installed on the front surface of the circuit board; and
a pressing device including a bottom plate and a pressing rod member, an elastic buckle is formed on the bottom plate, the pressing rod member is rotatably connected to the bottom plate and is rotatable between a closed position of pressing the connector onto the circuit board and an open position of releasing the connector, the elastic buckle engages with the pressing rod member when the pressing rod member is rotated to the closed position, the elastic buckle engaged with the pressing rod member locks the pressing rod member in the closed position, the bottom plate is fixed to the front surface of the circuit board, the pressing device applies a predetermined pressing force on the connector, such that the connector is pressed against the front surface of the circuit board.

18. The electrical connection assembly of claim 17, wherein the connector includes a housing and a terminal set in the housing, the pressing device includes a pressing cover connected to the pressing rod member, the pressing device applies a predetermined downward pressing force on a top of the housing of the connector through the pressing cover.

19. The electrical connection assembly of claim 17, wherein the connector has a housing with hook parts respectively formed on outer sides of two side walls of the connector, and a terminal set in the housing, a pair of pressing rods of the pressing device each have a U-shaped buckle, each U-shaped buckle is engaged with one hook part, the pressing device applies a predetermined downward pressing force on the housing when the hook parts are pressed.

20. The electrical connection assembly of claim 17, wherein the connector has a base installed on a bottom of a housing of the connector, a plurality of positioning pins are formed on a bottom surface of the base, and a plurality of positioning holes are formed in the circuit board, each positioning pin is mated with one positioning hole to position the connector on the circuit board.

21. The electrical connection assembly of claim 18, wherein the connector has a cable electrically connected to the terminal and extending from the housing.

22. The electrical connection assembly of claim 17, further comprising a back plate and a fastening assembly, the back plate is located on the back surface of the circuit board, the fastening assembly fixes the back plate and the bottom plate onto the circuit board.

23. The electrical connection assembly of claim 22, wherein the fastening assembly has a nut and a bolt, the nut is riveted to the bottom plate, the bolt passes through the back plate, the circuit board, and the bottom plate, and is threaded with the nut.
